(19) United States
(12) Patent Application Publication
(10) Pub. No.: US 2022/0195343 A1
(43) Pub. Date: Jun. 23, 2022

(54) METHOD OF LAUNDERING FABRIC

(71) Applicant: The Procter & Gamble Company, Cincinnati, OH (US)

(72) Inventors: Anju Deepali Massey BROOKER, Newcastle upon Tyne (GB); Carlos AMADOR ZAMARRENO, Newcastle upon Tyne (GB); Laura BUENO ROMO, Newcastle upon Tyne (GB); Evangelia ARGENTOU, Newcastle upon Tyne (GB)

(21) Appl. No.: 17/515,602

(22) Filed: Nov. 1, 2021

(30) Foreign Application Priority Data
Nov. 30, 2020 (EP) 20210729.8

(51) Int. Cl. C11D 3/37; C11D 11/00; C11D 1/83; C11D 3/00

(52) U.S. Cl. CPC C11D 3/3715; C11D 11/0017; C11D 1/22; C11D 3/0036; C11D 1/83

(57) ABSTRACT

The present invention relates to a method of laundering fabric which includes (a) contacting laundry detergent to water to form an aqueous wash liquor; (b) contacting fabric to the aqueous wash liquor, and washing the fabric in the aqueous wash liquor; (c) removing at least some of the aqueous wash liquor from the fabric, and rinsing the fabric with a first aqueous rinse solution in a first rinse step; (d) removing at least some of the first aqueous rinse solution from the fabric, and rinsing the fabric with a second aqueous rinse solution in a second rinse step; and (e) removing at least some of the second aqueous rinse solution from the fabric, wherein the first aqueous rinse solution is free from soil release polymer, and wherein the second aqueous rinse solution includes a soil release polymer that is a polyester soil release polymer.

### FIELD OF THE INVENTION

The present disclosure relates to a method of laundering fabric. The method controls the time of the addition of a specific soil release polymer to the fabric such that the soil release polymer is dosed during a second rinsing step. The method provides improved whiteness benefits, especially multicycle benefits and especially on cotton and particularly on knitted cotton.

### BACKGROUND OF THE INVENTION

Soil release polymers are typically added to the main wash step (usually by their incorporation into a detergent composition) to enhance the whiteness appearance of fabric. After the washing step, typically the fabrics undergo a rinsing step. Usually, ingredients such as perfume and fabric softeners are dosed into the rinsing step (usually by their incorporation into a rinse-added fabric enhancer composition).

The inventors have found that adding a specific soil release polymer into a second rinsing step improves the whiteness performance and provides whiteness benefits to fabric, especially cotton and particularly on knitted cotton, and especially after multiple cycles.

### SUMMARY OF THE INVENTION

The present disclosure includes a method of laundering fabric comprising: (a) contacting laundry detergent to water to form an aqueous wash liquor; (b) contacting fabric to the aqueous wash liquor, and washing the fabric in the aqueous wash liquor; (c) removing at least some of the aqueous wash liquor from the fabric, and rinsing the fabric with a first aqueous rinse solution in a first rinse step; (d) removing at least some of the first aqueous rinse solution from the fabric, and rinsing the fabric with a second aqueous rinse solution in a second rinse step; and (e) removing at least some of the second aqueous rinse solution from the fabric, wherein the first aqueous rinse solution is free from soil release polymer, and wherein the second aqueous rinse solution comprises a soil release polymer that is a polyester soil release polymer having a structure according to the formula below:

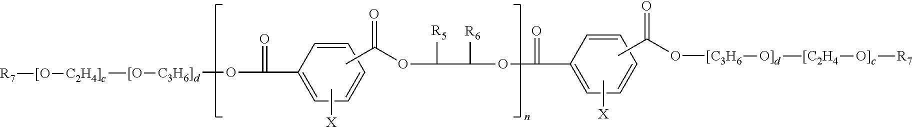

wherein:
R₅ and R₆ is independently selected from H or CH₃;
c, d are, based on molar average, a number independently selected from 0 to 200, and
wherein the sum of c+d is from 2 to 400;
R₇ is selected from C₁₋₄ alkyl, —CH₂—CH₂—SO₃⁻(Mⁱ⁺)_{y}, or

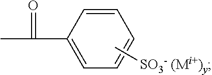

and
n is, based on molar average, from 1 to 50;
each X is independently selected from H or SO₃⁻(Mⁱ⁺)_{y};
wherein, M is H or a mono- or divalent cation;
i is 1 or 2;
y is 0.5 or 1; and
i×y is equal to 1.

### DETAILED DESCRIPTION OF THE INVENTION

Method of laundering fabric. A method of laundering fabric can comprise: (a) contacting laundry detergent to water to form an aqueous wash liquor; (b) contacting fabric to the aqueous wash liquor, and washing the fabric in the aqueous wash liquor; (c) removing at least some of the aqueous wash liquor from the fabric, and rinsing the fabric with a first aqueous rinse solution in a first rinse step; (d) removing at least some of the first aqueous rinse solution from the fabric, and rinsing the fabric with a second aqueous rinse solution in a second rinse step; and (e) removing at least some of the second aqueous rinse solution from the fabric, wherein the first aqueous rinse solution is free from soil release polymer, and wherein the second aqueous rinse solution comprises a soil release polymer that is a polyester soil release polymer having a structure according to the formula below:

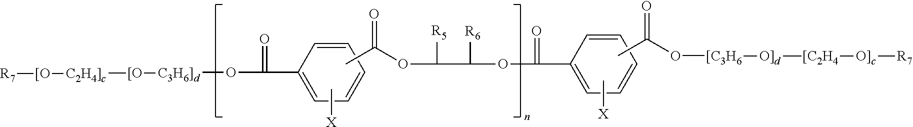

wherein:
R₅ and R₆ is independently selected from H or CH₃;
c, d are, based on molar average, a number independently selected from 0 to 200, and
wherein the sum of c+d is from 2 to 400;
R₇ is selected from C₁₋₄ alkyl, —CH₂—CH₂—SO₃⁻(Mⁱ⁺)_{y}, or

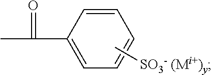

and
n is, based on molar average, from 1 to 50;
each X is independently selected from H or SO₃⁻(Mⁱ⁺)_{y};
wherein, M is H or a mono- or divalent cation;
i is 1 or 2;
y is 0.5 or 1; and
i×y is equal to 1.

Preferably, the method is carried out in an automatic washing machine.

It may be preferred that the pH of the aqueous wash liquor is controlled during step (b). It may be preferred that from the start of step (b) until 120 seconds into step (b), the pH of the aqueous wash liquor is in the range of from 6.0 to 8.5. It may be preferred that from after 2 120 seconds until 720 seconds into step (b), the pH of the aqueous wash liquor is in the range of from above 8.5 to 13.0, preferably from 11 to 12.5. It may be preferred that from after 720 seconds to the end of step (b), the pH of the aqueous wash liquor is in the range of from 6.0 to 8.5.

It may be preferred that the pH of the first aqueous rinse solution during the first rinsing step (c) is in the range of from 6.5 to 7.5, preferably 7.0.

It may be preferred that the pH of the second aqueous rinse solution during the second rinsing step (d) is in the range of from 3.0 to 5.0, preferably from 3.5 to 4.5.

The increase in pH can be achieved by the addition of alkaline ingredients, such as NaOH, for example NaOH aqueous solution (50% w). The decrease in pH can be achieved by the addition of acidic ingredients, such as HCl, for example HCl aqueous solution (50% w).

The terms: “free from” and “substantially free from” and “essentially free from” typically mean that no deliberate addition of the feature or chemistry occurs. So the term: “free from soil release polymer” means that no soil release polymer is deliberately added. Regarding the first aqueous rinse solution, trace amounts of soil release polymer that may be carried over from the aqueous washing step, if they were present, may still be present in the first aqueous rinsing solution. but any trace amount is preferably minimized in so far as it is reasonably possible.

Step (a) forming an aqueous wash liquor. During step (a), a laundry detergent is contacted to water to form an aqueous wash liquor.

Step (b) washing step. During step (b), fabric is contacted to the aqueous wash liquor, and the fabric is washed in the aqueous wash liquor.

Step (c) first rinsing step. During step (c), at least some of the wash liquor is removed from the fabric, and the fabric is rinsed with a first aqueous rinse solution in a first rinse step. Preferably, the majority of the wash liquor is removed from the fabric during step (c).

By removing a majority, it typically means removing more than 50 wt %, or more than 60 wt %, or more than 70 wt %, or even 80 wt %. Regarding the rinsing steps, the majority of the liquor or solution is removed, it is understood that residual liquor or solution (e.g. that which is absorbed or adsorbed by the fabric) will remain and be carried over to the subsequent step. Preferably this carry over is minimized in so far as it is reasonably possible to do so. Spinning the fabric, and especially in an automatic washing machine, may aid the removal of liquor or solution from the fabric.

Step (d) second rinsing step. During step (d), at least some of the first aqueous rinse solution is removed from the fabric, and the fabric is rinsed with a second aqueous rinse solution in a second rinse step. Preferably, the majority of the first aqueous rinse solution is removed from the fabric during step (d).

Step (e) During step (e), at least some of the second aqueous rinse solution is removed from the fabric. Preferably, the majority of the second aqueous rinse solution is removed from the fabric during step (e).

Optionally, during step (e), at least some of the second aqueous rinse solution is removed from the fabric, and the fabric is rinsed with a third aqueous rinse solution in a third rinse step. Preferably, the majority of the second aqueous rinse solution is removed from the fabric during step (e). The optional third aqueous rinse step can be the last rinse step.

Optional step (f). During the optional step (f), at least some of the third aqueous rinse solution is removed from the fabric. Preferably, the majority of the third aqueous rinse solution is removed from the fabric during step (f).

Aqueous wash liquor. The aqueous wash liquor typically comprises anionic surfactant. The aqueous wash liquor may comprise soil release polymer. The aqueous wash liquor may also comprise anionic surfactant and soil release polymer.

The aqueous wash liquor may comprise any suitable detergent ingredient. Typically, the aqueous wash liquor comprises from 100 ppm to 2000 ppm, or from 200 ppm to 1500 ppm, or from 300 ppm to 1000 ppm detersive surfactant.

The aqueous wash liquor may comprise one or more ingredients commonly used for formulating laundry detergent compositions, such as builders, fillers, carriers, structurants or thickeners, clay soil removal/anti-redeposition agents, polymeric soil release agents, polymeric dispersing agents, polymeric grease cleaning agents, enzymes, enzyme stabilizing systems, amines, bleaching compounds, bleaching agents, bleach activators, bleach catalysts, brighteners, dyes, hueing agents, dye transfer inhibiting agents, chelating agents, softeners or conditioners (such as cationic polymers or silicones), perfumes (including perfume encapsulates), hygiene and malodor treatment agents, and any combination thereof. Preferably, the aqueous wash liquor substantially free of any fabric softening agent.

Aqueous rinsing solutions. The aqueous rinsing solutions may comprise rinse-added ingredients such as perfume and fabric-softening agents. It may also be preferred for some of the aqueous rinsing solutions to also comprise brighteners, hueing dyes, enzymes and any combination thereof.

First aqueous rinse solution. The first aqueous rinse solution is free from soil release polymer. The first aqueous rinse solution can be water.

Second aqueous rinse solution. The second aqueous rinse solution comprises polyester soil release polymer having a structure according to the formula below:

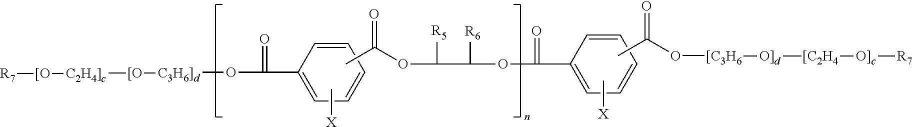

wherein:
R₅ and R₆ is independently selected from H or CH₃;
c and d are, based on molar average, a number independently selected from 0 to 200, and
wherein the sum of c+d is from 2 to 400;
R₇ is selected from C₁₋₄ alkyl, —CH₂—CH₂—SO₃⁻(Mⁱ⁺)_{y}, or

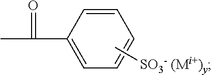

more preferably methyl; and
n is, based on molar average, from 1 to 50;
each X is independently selected from H or SO₃⁻(Mⁱ⁺)_{y};
wherein, M is H or a mono- or divalent cation;
i is 1 or 2;
y is 0.5 or 1; and
i×y is equal to 1.

More preferably, M is H or an alkali metal cation and/or earth alkali metal ion.

Even more preferably, the second aqueous rinse solution comprises a nonionic terephthalate-derived soil release polymer having a structure according to the formula below:

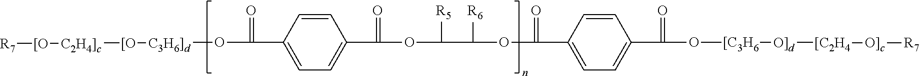

wherein:
R₅ and R₆ is independently selected from H or CH₃, more preferably, one of the R₅ and R₆ is H, and another is CH₃;
c and d are, based on molar average, a number independently selected from 0 to 200, and wherein the sum of c+d is from 2 to 400, more preferably, d is from 0 to 50 and c is from 1 to 200, more preferably, d is 0 to 10 and c is 5 to 150;
R₇ is C₁₋₄ alkyl and more preferably methyl; and
n is, based on molar average, from 1 to 50.

Typically, the second aqueous rinse solution comprises from 10 ppm to 200 ppm, or from 20 ppm to 150 ppm, or from 40 ppm to 120 ppm soil release polymer.

The second aqueous rinse solution can be the last aqueous rinse solution. However, typically the method comprises a third rinsing step, and the method can even comprise a fourth, fifth or even sixth rinse step.

Optional third aqueous rinse solution. The third aqueous rinse solution can be free from soil release polymer. The optional third aqueous rinse solution can be the last aqueous rinse solution. However, there may be other rinsing steps after the optional third rinsing step, so the last aqueous rinse solution can be the fourth, fifth or even sixth aqueous rinse solution.

Last aqueous rinse solution. Preferably, the last aqueous rinse solution comprises perfume and/or fabric softening agent. It may also be preferred for the last aqueous rinsing solution to also comprise brighteners, hueing dyes, enzymes and any combination thereof.

Laundry detergent. Typically, the laundry detergent comprises anionic surfactant and soil release polymer. The laundry detergent typically comprises other detergent ingredients. The detergent ingredients are described in more detail below.

Soil release polymer. The soil release polymer has a structure according to the formula below:

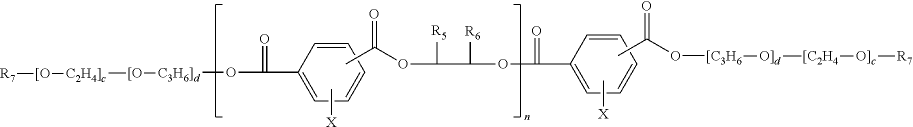

wherein:
R₅ and R₆ is independently selected from H or CH₃;
c and d are, based on molar average, a number independently selected from 0 to 200, and
wherein the sum of c+d is from 2 to 400;
R₇ is selected from C₁₋₄ alkyl, —CH₂—CH₂—SO₃⁻(Mⁱ⁺)_{y}, or

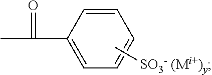

more preferably methyl; and
n is, based on molar average, from 1 to 50;
each X is independently selected from H or SO₃⁻(Mⁱ⁺)_{y};
wherein, M is H or a mono- or divalent cation;
i is 1 or 2;
y is 0.5 or 1; and
i×y is equal to 1.

More preferably, M is H or an alkali metal cation and/or earth alkali metal ion.

Even more preferably, the soil release polymer is a nonionic terephthalate-derived soil release polymer having a structure according to the formula below:

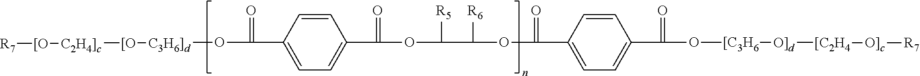

wherein:
R₅ and R₆ is independently selected from H or CR, more preferably, one of the R₅ and R₆ is H, and another is CH₃;
c and d are, based on molar average, a number independently selected from 0 to 200, and
wherein the sum of c+d is from 2 to 400, more preferably, d is from 0 to 50 and c is from 1 to 200, more preferably, d is 0 to 10 and c is 5 to 150;
R₇ is C₁₋₄ alkyl and more preferably methyl; and
n is, based on molar average, from 1 to 50.

Suitable terephthalate-derived soil release polymers may be also described as sulphonated and unsulphonated PET/POET (polyethylene terephthalate/polyoxyethylene terephthalate) polymers, both end-capped and non-end-capped. A suitable soil release polymer is the SRN series of polymers from Clariant, or the SRA series of polymers also from Clariant. Suitable soil release polymer including TexCare® SRN-100, SRN-170, SRN-240, SRN-260, SRN-260 Life, SRN-300, SRN-325, SRA-100, SRA-300. Other suitable soil release polymer of this type are WeylClean PSA1, PLN1, PLN2 from Weylchem.

Other suitable terephthalate-derived soil release polymers are described in patent WO2014019903, WO2014019658 and WO2014019659. EP3650500 also describes a suitable soil release polymer with at least one end capping group have a structure corresponding to formula: X—(OC₂H₄)ₙ—(OC₃H₆)ₘ wherein
X is C₁₋₄ alkyl, more preferably methyl.
the —(OC₂H₄) groups and the —(OC₃H₆) groups are arranged blockwise and the block consisting of the —(OC₃H₆) groups is bound to a COO group,
n is based on a molar average a number of from 40 to 50, more preferably 43 to 47,
m is based on a molar average a number of from 1 to 7, more preferably 2 to 5.

Detergent ingredients. Suitable detergent ingredients include at least one of a surfactant, an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a bleaching agent, a bleach activator, a bleaching catalyst, a fabric conditioner, a clay, a foam booster, an anti-foam, a suds suppressor, an anti-corrosion agent, a soil-suspending agent, a dye, a hueing dye, a bactericide, a tarnish inhibitor, an optical brightener, a perfume, a saturated or unsaturated fatty acid, a calcium cation, a magnesium cation, a visual signaling ingredient, a structurant, a thickener, an anti-caking agent, a starch, sand, a gelling agents, or any combination thereof.

Surfactant System: The composition may comprise a surfactant system in an amount sufficient to provide desired cleaning properties. In some embodiments, the composition comprises, by weight of the composition, from about 1% to about 70% of a surfactant system. In other embodiments, the composition comprises, by weight of the composition, from about 2% to about 60% of the surfactant system. In further embodiments, the composition comprises, by weight of the composition, from about 5% to about 30% of the surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material.

Anionic Surfactant. Non-limiting examples of suitable anionic surfactants include any conventional anionic surfactant, such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap.

Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

The detersive surfactant may be a mid-chain branched detersive surfactant, in one aspect, a mid-chain branched anionic detersive surfactant, in one aspect, a mid-chain branched alkyl sulphate and/or a mid-chain branched alkyl benzene sulphonate, for example, a mid-chain branched alkyl sulphate. In one aspect, the mid-chain branches are C₄ alkyl groups, typically methyl and/or ethyl groups.

Other anionic surfactants useful herein are the water-soluble salts of: paraffin sulfonates and secondary alkane sulfonates containing from about 8 to about 24 (and in some examples about 12 to 18) carbon atoms: alkyl glyceryl ether sulfonates, especially those ethers of C₈₋₁₈ alcohols (e.g., those derived from tallow and coconut oil). Mixtures of the alkylbenzene sulfonates with the above-described paraffin sulfonates, secondary alkane sulfonates and alkyl glyceryl ether sulfonates are also useful. Further suitable anionic surfactants include methyl ester sulfonates and alkyl ether carboxylates (AEC).

Suitable anionic surfactant also includes branched anionic surfactant. anionic branched surfactants selected from branched sulphate or branched sulphonate surfactants. Further suitable branched anionic detersive surfactants include surfactants derived from alcohols branched in the 2-alkyl position, such as those sold under the trade names Isalchem®123, Isalchem®125, Isalchem®145, Isalchem®167, which are derived from the oxo process. Due to the oxo process, the branching is situated in the 2-alkyl position. These 2-alkyl branched alcohols are typically in the range of C11 to C14/C15 in length and comprise structural isomers that are all branched in the 2-alkyl position.

The anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

Nonionic surfactant. Suitable nonionic surfactants useful herein can comprise any conventional nonionic surfactant. These can include, for e.g., alkoxylated fatty alcohols and amine oxide surfactants. Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates wherein the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA): C₁₄-C₂₂ mid-chain branched MEA (BAEₓ), wherein x is from 1 to 30; alkylpolysaccharides; specifically alkylpolyglycosides; Polyhydroxy fatty acid amides; and ether capped poly(oxyalkylated) alcohol surfactants. Suitable nonionic detersive surfactants also include alkyl polyglucoside and alkyl alkoxylated alcohol. Suitable nonionic surfactants also include those sold under the tradename Lutensolt® from BASF.

Cationic Surfactant. The surfactant system may comprise a cationic surfactant. In some aspects, the surfactant system comprises from about 0% to about 7%, or from about 0.1% to about 5%, or from about 1% to about 4%, by weight of the surfactant system, of a cationic surfactant, e.g., as a co-surfactant. In some aspects, the compositions of the invention are substantially free of cationic surfactants and surfactants that become cationic below a pH of 7 or below a pH of 6. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, specifically amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof.

Zwitterionic Surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Betaines, including alkyl dimethyl betaine and cocodimethyl amidopropyl betaine, C₈ to C₁₈ (for example from C₁₂ to C₁₈) amine oxides and sulfo and hydroxy betaines, such as N-alkyl-N,N-dimethylammino-1-propane sulfonate where the alkyl group can be C₈ to C₁₈ and in certain embodiments from C₁₀ to C₁₄.

Amphoteric Surfactant. Examples of amphoteric surfactants include aliphatic derivatives of secondary or tertiary amines, or aliphatic derivatives of heterocyclic secondary and tertiary amines in which the aliphatic radical may be straight- or branched-chain and where one of the aliphatic substituents contains at least about 8 carbon atoms, typically from about 8 to about 18 carbon atoms, and at least one of the aliphatic substituents contains an anionic water-solubilizing group, e.g. carboxy, sulfonate, sulfate. Examples of compounds falling within this definition are sodium 3-(dodecylamino)propionate, sodium 3-(dodecylamino) propane-1-sulfonate, sodium 2-(dodecylamino)ethyl sulfate, sodium 2-(dimethylamino) octadecanoate, disodium 3-(N-carboxymethyldodecylamino)propane 1-sulfonate, disodium octadecyl-imminodiacetate, sodium 1-carboxymethyl-2-undecylimidazole, and sodium N,N-bis (2-hydroxyethyl)-2-sulfato-3-dodecoxypropylamine. Suitable amphoteric surfactants also include sarcosinates, glycinates, taurinates, and mixtures thereof.

Enzymes. Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), especially those derived from Bacillus, such as Bacillus sp., B. lentus, B. alkalophilus, B. subtilis, B. amyloliquefaciens, B. pumilus, B. gibsonii, and B. akibaii described in WO2004067737, WO2015091989, WO2015091990, WO2015024739, WO2015143360, U.S. Pat. No. 6,312,936 B1, U.S. Pat. Nos. 5,679,630, 4,760,025, DE102006022216A1, DE102006022224A1, WO2015089447, WO2015089441, WO2016066756, WO2016066757, WO2016069557, WO2016069563. WO2016069569.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.

(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzymet, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXPt by Dupont; those sold under the tradename Opticlean® and Optimase® by Solvay Enzymes; and those available from Henkel/Kemira, namely BLAP (shown in FIG. 29 of U.S. Pat. No. 5,352,604), and KAP (Bacillus alkalophilus subtilisin with mutations A230V+S256G+S259N) from Kao.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) variants described in WO 94/02597, WO 94/18314, WO96/23874 and WO 97/43424,

(b) variants described in U.S. Pat. No. 5,856,164 and WO99/23211, WO 9623873, WO00/60060 and WO 06/002643,

(c) variants in WO06/002643, and variants described in WO 00/60060, which is incorporated herein by reference.

(d) variants in U.S. Pat. No. 6,093,562;

(e) variants described in WO 09/149130,

(f) variants in WO2016091688,

(g) variants exhibiting at least 60% amino acid sequence identity with the “PcuAmy1 α-amylase” from Paenibacillus curdlanolyticus YK9 in WO2014099523.

(h) variants exhibiting at least 60% amino acid sequence identity with the “CspAmy2 amylase” from Cytophaga sp. in WO2014164777.

(i) variants exhibiting at least 85% identity with AmyE from Bacillus subtilis in WO2009149271.

(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, Calif.) and KAM® (Kao, 14-10 Nihonbashi Kayabacho, 1-chome, Chuo-ku Tokyo 103-8210, Japan). In one aspect, suitable amylases include NATALASE41, STAINZYME® and STAINZYME PLUS® and mixtures thereof.

Lipases. Preferably the composition comprises one or more lipases, including “first cycle lipases” such as those described in U.S. Pat. No. 6,939,702 B1 and US PA 2009/0217464. Preferred lipases are first-wash lipases. The composition may comprise a first wash lipase.

First wash lipases includes a lipase which is a polypeptide having an amino acid sequence which: (a) has at least 90/6 identity with the wild-type lipase derived from Humicola lanuginosa strain DSM 4109; (b) compared to said wild-type lipase, comprises a substitution of an electrically neutral or negatively charged amino acid at the surface of the three-dimensional structure within 15A of E1 or Q249 with a positively charged amino acid; and (c) comprises a peptide addition at the C-terminal; and/or (d) comprises a peptide addition at the N-terminal and/or (e) meets the following limitations: i) comprises a negative amino acid in position E210 of said wild-type lipase; ii) comprises a negatively charged amino acid in the region corresponding to positions 90-101 of said wild-type lipase: and iii) comprises a neutral or negative amino acid at a position corresponding to N94 or said wild-type lipase and/or has a negative or neutral net electric charge in the region corresponding to positions 90-101 of said wild-type lipase.

Preferred are variants of the wild-type lipase from Thermomyces lanuginosus comprising one or more of the T231R and N233R mutations. The wild-type sequence is the 269 amino acids (amino acids 23-291) of the Swissprot accession number Swiss-Prot 059952 (derived from Thermomyces lanuginosus (Humicola lamginosa)). Preferred lipases would include those sold under the tradenames Lipex® and Lipolex® and Lipoclean®.

Cellulases. Suitable cellulases are from a bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500(B)® (Kao Corporation).

The bacterial cleaning cellulase may be a glycosyl hydrolase having enzymatic activity towards amorphous cellulose substrates, wherein the glycosyl hydrolase is selected from GH families 5, 7, 12, 16, 44 or 74. Suitable glycosyl hydrolases may also be selected from the group consisting of: GH family 44 glycosyl hydrolases from Paenibacillus polyxyma (wild-type) such as XYG1006 described in U.S. Pat. No. 7,361,736 or are variants thereof. GH family 12 glycosyl hydrolases from Bacillus licheniformis (wild-type) such as described in U.S. Pat. No. 6,268,197 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022 described in U.S. Pat. No. 6,630,340 or variants thereof: GH family 74 glycosyl hydrolases from Jonesia sp. (wild type) such as XYG1020 described in WO 20021077242 or variants thereof; and GH family 74 glycosyl hydrolases from Trichoderma Reesei (wild type), such as the enzyme described in U.S. Pat. No. 7,172,891, or variants thereof. Suitable bacterial cleaning cellulases are sold under the tradenames Celluclean® and Whitezyme® (Novozymes A/S, Bagsvaerd, Denmark).

The composition may comprise a fungal cleaning cellulase belonging to glycosyl hydrolase family 45 having a molecular weight of from 17 kDa to 30 kDa, for example the endoglucanases sold under the tradename Biotouch® NCD, DCC and DCL (AB Enzymes, Darmstadt, Germany).

Pectate Lyases. Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, Calif.).

Nuclease enzyme. The composition may comprise a nuclease enzyme. The nuclease enzyme is an enzyme capable of cleaving the phosphodiester bonds between the nucleotide sub-units of nucleic acids. The nuclease enzyme herein is preferably a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus, it includes truncated, but functional versions, of the enzyme and/or variants and/or derivatives and/or homologues whose functionality is maintained.

Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Mannanases. The composition may comprise an extracellular-polymer-degrading enzyme that includes a mannanase enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; 3-1,4-mannan 4-mannanohydrolase; endo-3-mannanase; and β-D-mannanase. For purposes of the present disclosure, mannanase activity may be determined using the Reducing End Assay as described in the experimental section of WO2015040159. Suitable examples from class EC 3.2.1.78 are described in WO2015040159.

Galactanases. The composition may comprise an extracellular polymer-degrading enzyme that includes an endo-beta-1,6-galactanase enzyme. The term “endo-beta-1,6-galactanase” or “a polypeptide having endo-beta-1,6-galactanase activity” means a endo-beta-1,6-galactanase activity (EC 3.2.1.164) from the glycoside hydrolase family 30 that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals. For purposes of the present disclosure, endo-beta-1,6-galactanase activity is determined according to the procedure described in WO 2015185689 in Assay I. Suitable examples from class EC 3.2.1.164 are described in WO 2015185689.

Enzyme Stabilizing System. The composition may optionally comprise from about 0.001% to about 10% by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builder. The composition may optionally comprise a builder or a builder system. Built cleaning compositions typically comprise at least about 1% builder, based on the total weight of the composition. Liquid cleaning compositions may comprise up to about 10% builder, and in some examples up to about 8% builder, of the total weight of the composition. Granular cleaning compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing cleaning compositions. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Also suitable for use as builders herein are synthesized crystalline ion exchange materials or hydrates thereof having chain structure and a composition represented by the following general anhydride form: x(M₂O).ySiO₂.zM′O wherein M is Na and/or K, M′ is Ca and/or Mg; y/x is 0.5 to 2.0; and z/x is 0.005 to 1.0.

Alternatively, the composition may be substantially free of builder.

Chelating Agent. The composition may also comprise one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins, and mixtures therein. Chelating agents can be present in the acid or salt form including alkali metal, ammonium, and substituted ammonium salts thereof, and mixtures thereof.

Aminocarboxylates useful as chelating agents include, but are not limited to ethylenediaminetetracetates (EDTA); N-(hydroxyethyl)ethylenediaminetriacetates (HEDTA); nitrilotriacetates (NTA); ethylenediamine tetraproprionates; triethylenetetraaminehexacetates, diethylenetriamine-pentaacetates (DTPA); methylglycinediacetic acid (MGDA); Glutamic acid diacetic acid (GLDA); ethanoldiglycines; triethylenetetraaminehexaacetic acid (TTHA); N-hydroxyethyliminodiacetic acid (HEIDA); dihydroxyethylglycine (DHEG); ethylenediaminetetrapropionic acid (EDTP) and derivatives thereof.

Carboxylate polymer. The composition may comprise one or more carboxylate polymers as polymeric dispersing agents, anti-redeposition agent, or as cleaning polymer. The carboxylate polymers may comprise at least one monomer selected from acrylic acid, maleic acid (or maleic anhydride), fumaric acid, itaconic acid, aconitic acid, mesaconic acid, citraconic acid, methylenemalonic acid, and any mixture thereof. In one aspect, suitable carboxylate polymers can include maleate/acrylate random copolymer or polyacrylate homopolymer.

In another aspect, the carboxylate polymers may further comprise other monomers. Suitable other monomers may include sulfonated monomers, such as 2-acrylamido-2-methylpropane sulfonic acid (AMPS), 2-(meth)acrylamido-2-methylpropane sulfonic acid, 4-styrenesulfonic acid, vinylsulfonic acid, 3-allyloxy, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, and 4-sulfobutyl(meth)acrylic acid, and the salt thereof.

Suitable other monomers may also include hydrophobic modified monomers, such as alkyl acrylate, or monomer represented by formulas (I) and (II):

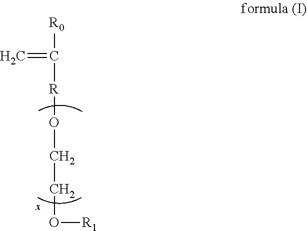

wherein in formula (I). R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

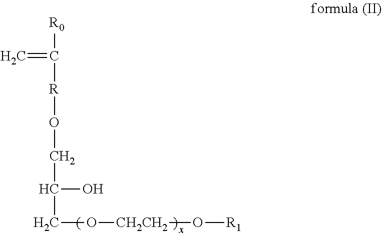

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂ organic group.

Amphiphilic cleaning polymer. The composition may comprise one or more amphiphilic cleaning polymers such as the compound having the following general structure: bis((C₂H₅O)(C₂H₄O)n)(CH₃)—N⁺—CₓH₂ₓ—N—(CH₃)-bis((C₂H₅O)(C₂H₄O)n), wherein n=from 20 to 30, and x=from 3 to 8, or sulphated or sulphonated variants thereof.

The composition may comprise amphiphilic alkoxylated greasecleaning polymers which have balanced hydrophilic and hydrophobic properties such that they remove grease particles from fabrics and surfaces. Specific embodiments of the amphiphilic alkoxylated grease cleaning polymers comprise a core structure and a plurality of alkoxylate groups attached to that core structure. These may comprise alkoxylated polyalkylenimines, for example, having an inner polyethylene oxide block and an outer polypropylene oxide block.

Alkoxylated polyamines may be used for grease and particulate removal. Such compounds may include, but are not limited to, ethoxylated polyethyleneimine, ethoxylated hexamethylene diamine, and sulfated versions thereof. Polypropoxylated derivatives may also be included. A wide variety of amines and polyalkyeneimines can be alkoxylated to various degrees. A useful example is 600 g/mol polyethyleneimine core ethoxylated to 20 EO groups per NH and is available from BASF.

The cleaning composition may comprise random graft polymers comprising a hydrophilic backbone comprising monomers, for example, unsaturated C1-C6 carboxylic acids, ethers, alcohols, aldehydes, ketones, esters, sugar units, alkoxy units, maleic anhydride, saturated polyalcohols such as glycerol, and mixtures thereof; and hydrophobic side chain(s), for example, one or more C₄-C₂₅ alkyl groups, polypropylene, polybutylene, vinyl esters of saturated C₁-C₆ mono-carboxylic acids, C₁-C₆ alkyl esters of acrylic or methacrylic acid, and mixtures thereof. A specific example of such graft polymers based on polyalkylene oxides and vinyl esters, in particular vinyl acetate. These polymers are typically prepared by polymerizing the vinyl ester in the presence of the polyalkylene oxide, the initiator used being dibenzoyl peroxide, dilauroyl peroxide or diacetyl peroxide.

The cleaning composition may comprise blocks of ethylene oxide, propylene oxide. Examples of such block polymers include ethylene oxide-propylene oxide-ethylene oxide (EO/PO/EO) triblock copolymer, wherein the copolymer comprises a first EO block, a second EO block and PO block wherein the first EO block and the second EO block are linked to the PO block. Blocks of ethylene oxide, propylene oxide, butylene oxide can also be arranged in other ways, such as (EO/PO) deblock copolymer, (PO/EO/PO) triblock copolymer. The block polymers may also contain additional butylene oxide (BO) block.

Cellulosic Polymer. The composition may comprise from about 0.1% to about 10%, by weight of the composition, of a cellulosic polymer.

Suitable cellulosic polymers include alkyl cellulose, alkylalkoxyalkyl cellulose, carboxyalkyl cellulose, and alkyl carboxyalkyl cellulose. In some aspects, the cellulosic polymer is selected from carboxymethyl cellulose, methyl cellulose, methyl hydroxyethyl cellulose, methyl carboxymethyl cellulose, or mixtures thereof. In certain aspects, the cellulosic polymer is a carboxymethyl cellulose having a degree of carboxymethyl substitution of from about 0.5 to about 0.9 and a molecular weight from about 100,000 Da to about 300,000 Da.

Carboxymethylcellulose polymers include Finnfix® GDA (sold by CP Kelko), a hydrophobically modified carboxymethylcellulose, e.g., the alkyl ketene dimer derivative of carboxymethylcellulose sold under the tradename Finnfix® SH1 (CP Kelko), or the blocky carboxymethylcellulose sold under the tradename Finnfix®V (sold by CP Kelko).

Suitable cellulosic polymers also include cellulose polymers with cationic modification and/or hydrophilic modifications. Suitable cationic modified cellulose polymers include UCARE JR125, UCARE JR400, UCARE JR30M, UCARE LR400, UCARE LR30M, SOFTCAT SL-5, SOFTCAT SL-30, SOFTCAT SL-60, SOFTCAT SL-100, SOFTCAT SX-400X, SOFTCAT SX-1300H, SOFTCAT SX-1300X, SOFTCAT SK-H, and SOFTCAT SK-MH, all of which are sold by The Dow Chemical.

Additional Amines: Additional amines may be used in the composition for added removal of grease and particulates from soiled materials. The compositions may comprise from about 0.1% to about 10%, in some examples, from about 0.1% to about 4%, and in other examples, from about 0.1% to about 2%, by weight of the cleaning composition, of additional amines. Non-limiting examples of additional amines may include, but are not limited to, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Dye Transfer Inhibiting Agent. The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid: citric acid and any salts thereof: N-hydroxyethylethylenediaminetri-acetic acid (HEDTA), triethylenetetraaminehexaacetic acid (TTHA). N-hydroxyethyliminodiacetic acid (HEIDA), dihydroxyethylglycine (DHEG), ethylenediaminetetrapropionic acid (EDTP) and derivatives thereof or a combination thereof.

Bleaching Compounds, Bleaching Agents, Bleach Activators, and Bleach Catalysts. The compositions described herein may comprise bleaching agents, bleach activators and/or bleach catalysts. Bleaching ingredients may be present at levels of from about 1% to about 30%, and in some examples from about 5% to about 20%, based on the total weight of the composition. If present, the amount of bleach activator may be from about 0.1% to about 60%, and in some examples from about 0.5% to about 40%, of the composition.

Examples of bleaching agents include oxygen bleach, perborate bleach, percarboxylic acid bleach and salts thereof, peroxygen bleach, persulfate bleach, percarbonate bleach, and mixtures thereof.

In some examples, compositions may also include a transition metal bleach catalyst.

Bleaching agents other than oxygen bleaching agents are also known in the art and can be utilized in composition. They include, for example, photoactivated bleaching agents, or pre-formed organic peracids, such as peroxycarboxylic acid or salt thereof, or a peroxysulphonic acid or salt thereof. A suitable organic peracid is phthaloylimidoperoxycaproic acid. If used, the composition will typically comprise from about 0.025% to about 1.25%, by weight of the composition, of such bleaches, and in some examples, of sulfonate zinc phthalocyanine.

Brightener. Optical brighteners or other brightening or whitening agents may be incorporated at levels of from about 0.01% to about 1.2%, by weight of the composition.

Commercial brighteners, which may be used herein, can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, monoethanolamine, propane diol.

Fabric Hueing Agent. The composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisam, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Encapsulate. The composition may comprise an encapsulate. The encapsulate may comprises a core, a shell having an inner and outer surface, where the shell encapsulates the core.

In certain aspects, the encapsulate comprises a core and a shell, where the core comprises a material selected from perfumes; brighteners; dyes; insect repellants; silicones; waxes; flavors; vitamins; fabric softening agents: skin care agents. e.g., paraffins; enzymes; anti-bacterial agents; bleaches; sensates; or mixtures thereof; and where the shell comprises a material selected from polyethylenes; polyamides; polyvinylalcohols, optionally containing other co-monomers; polystyrenes; polyisoprenes; polycarbonates; polyesters; polyacrylates; polyolefins; polysaccharides, e.g., alginate and/or chitosan; gelatin; shellac; epoxy resins; vinyl polymers; water insoluble inorganics; silicone; aminoplasts, or mixtures thereof. In some aspects, where the shell comprises an aminoplast, the aminoplast comprises polyurea, polyurethane, and/or polyureaurethane. The polyurea may comprise polyoxymethyleneurea and/or melamine formaldehyde.

Other ingredients. The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition.

The composition can further comprise other conventional detergent ingredients such as fabric conditioners, clays, foam boosters, suds suppressors, anti-corrosion agents, soil-suspending agents, anti-soil redeposition agents, dyes, bactericides, tarnish inhibiters, optical brighteners, or perfumes.

The composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic cellulose, cationic starch, cationic polyacylamides or a combination thereof. If present, the fatty acids and/or the deposition aids can each be present at 0.1% to 10% by weight, based on the total weight of the composition.

The composition may optionally include silicone or fatty-acid based suds suppressors; hueing dyes, calcium and magnesium cations, visual signaling ingredients, anti-foam (0.001% to about 4.0% by weight, based on the total weight of the composition), and/or a structurant/thickener (0.01% to 5% by weight, based on the total weight of the composition) selected from the group consisting of diglycerides and triglycerides, ethylene glycol distearate, microcrystalline cellulose, microfiber cellulose, biopolymers, xanthan gum, gellan gum, and mixtures thereof).

### EXAMPLES

### Example 1. Comparative Stain Removal Performance of Fabric Treatment Process as a Function of Soil Release Polymer Injected Through the Wash

All experiments are carried out using an electrolux W565H programmable front-loading washing machine (FLWM). All machines are cleaned prior to use by conducting a 90° C. cotton cycle. Next, all the experiments are conducted using a washing cycle at 40° C. for 45 minutes where the main wash duration is 30 minutes and two rinse cycles of 6 minutes each. The remaining 3 minutes being the time to drain the drum and spin the fabrics between each step. In all cases the ballast load is comprised of 60% of knitted cotton swatches (50 cm×50 cm) and 40% of polycotton fabric swatches (50 cm×50 cm). Furthermore, a set of whiteness tracers comprising flat cotton and polyester swatches (20 cm×20 cm) with four internal repeats are added to each wash. All swatches are supplied by Warwick Equest Ltd (UK). All experiments are conducted with a liquid detergent formulation with the composition described in Table 1 (as TTW of the respective ingredients in the aqueous wash liquor formed thereby). The hardness of the water used in all experiments is moderate (˜8 gpg).

TABLE 1

| Group | Component | TTW (ppm) |
|---|---|---|
| Surfactants | Sodium dodecyl benzenesulfonate | 357 |
| | (LAS) | |
| | C14-15 AA with 7 EO | 202 |
| | C12-14 AES with 3 EO (70%) | 220 |
| | Lauramine oxide | 19 |
| Builders/ | Fatty Acids | 121 |
| Chelant | Citric Acid | 156 |
| | Diethylene triamine penta(methyl | 18 |
| | phosphonic acid) (DTPMP) | |
| Performance | Polymer Lutensit Z96 | 25 |
| actives/ | Polyethylene glycol (PEG)-co- | 51 |
| preservatives | polyvinyl acetate (PvAc) | |
| | Brighteners | 4 |
| | Preservatives | 0.1 |
| Enzymes/ | Protease | 2 |
| stabilisers | Na Formate (40% solution) | 52 |
| Solvent/ | Ethanol | 19 |
| neutralizer/ | 1,2 Propylene glycol | 190 |
| structrant | NaOH | 204 |
| | MEA hydrogenated castor oil | 15 |

In all cases, 3 kg ballast load with the composition previously described, one 30 g AS1 soil sheet (Warwick Equest Ltd., UK) and 1 set of whiteness tracers, are first added into the drum of the washing machine. Next, in the reference washing process (experiment A), the required dosage of liquid detergent formulation (38 g) containing the Soil release polymer* is added into a small plastic container and introduced into the drum of the washing machine (to give 100 ppm SRP) prior to start the washing cycle.

In other wash processes, after the addition of the ballast load, the soil sheet, the whiteness tracers and the required dosage of liquid detergent formulation (38 g), the required volume of a soil release polymer aqueous solution is injected at different points in time as described below for each comparative wash process (B-F). The total amount of soil release polymer present in the wash is kept constant across all experiments (A-F).
B) Comparative: Soil release polymer* (100 ppm TTW) injected in rinse 1 at t=0 min.
C) Inventive: Soil release polymer* (100 ppm TTW) injected in rinse 2 at t=0 min.
D) Comparative: Soil release polymer* (50 ppm TTW) injected in rinse 1 at t=0 min and 50 ppm injected in rinse 2 at time t=0 min.
E) Comparative: Soil release polymer* (50 ppm TTW) injected in main wash at t=0 min and 50 ppm TTW injected in rinse 1 at time t=0 min.
F) Inventive: Soil release polymer* (50 ppm TTW) injected in main wash at t=0 min and 50 ppm injected in rinse 2 at time t=0 min.
   *Soil release polymer is Texcare SRN260 from Clariant.
   In summary:
   Experiment A is a reference where the SRP (100 ppm) is added to the main wash.
   Experiment B is a comparative where the SRP (100 ppm) is added to the first rinse only (not the second rinse).
   Experiment C is in accordance with the present invention where the SRP (100 ppm) is added to the second rinse only.
   Experiment D is a comparative where half of the SRP (50 ppm) is added to the first rinse and half of the SRP (50 ppm) is added to the second rinse (so the first rinse is not free from the SRP).
   Experiment E is a comparative where half of the SRP (50 ppm) is added to the main wash and half of the SRP (50 ppm) is added to the first rinse (not the second rinse).
   Experiment F is in accordance with the present invention where half the SRP (50 ppm) is added to the main wash and half of the SRP (50 ppm) is added to the second rinse.
   The only difference between these experiments is the time of dosing the SRP into the laundering process. The total SRP load in each experiment was 100 ppm.

The addition of the soil release polymer is conducted via the drawer of the washing machine followed by the addition of 0.1 L of water to ensure no residual chemistry was left in the drawer of the machine. The rinse compositions used in the experiments were water, and if present (as indicated above), SRP.

All the experiments were conducted considering 4 external repeats. After each cycle is finished, the ballast load and the whiteness tracers are removed from the washing machine and introduced in an Electrolux T3290 gas dryer where they are dried for 30 minutes at low temperature. All the washing machines are then rinsed using a 4 minute rinse cycle before commencing the next experiment.

The L*a*b* values of the whiteness swatches are measured under D65 standard illumination conditions, C10° observer and SCE component. Afterwards, the delta CIE WI is calculated as the difference in the whiteness index before and after wash for each of the whiteness swatches. The results presented in Table 2 correspond to the average of the 4 internal repeats for each experimental condition and the 4 external repeats after 4 washing cycles.

TABLE 2

| Whiteness | | | | | | |
|---|---|---|---|---|---|---|
| tracer | A (Reference) | ΔB | ΔC | ΔD | ΔE | ΔF |
| Knitted Cotton | Ref | −0.02 | 0.39 | −3.78 | −0.18 | 1.89 |
| Polycotton | Ref | 0.23 | 0.42 | −0.77 | −0.77 | 0.31 |

When the soil release polymer is added in the last rinsing cycle (experiment D and F), it provides greater whiteness benefits.
Experiment C shows superior whiteness benefit compared to Experiment B. The difference between experiments C and B is that the inventive experiment introduced SRP into the second rinse (experiment C) whereas the comparative experiment introduced SRP into the first rinse (experiment B).
Experiment F shows superior whiteness benefit compared to Experiments D and E. The difference between these experiments is that the inventive experiment split the SRP load between the main wash and the second rinse (experiment F) whereas the comparative experiments split the STP load between the main wash and first rinse (experiment E), and the first rinse and second rinse (experiment D).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric comprising:
(a) contacting laundry detergent to water to form an aqueous wash liquor;
(b) contacting fabric to the aqueous wash liquor, and washing the fabric in the aqueous wash liquor;
(c) removing at least some of the aqueous wash liquor from the fabric, and dosing a first aqueous rinse solution to the fabric, and rinsing the fabric in a first rinse step;
(d) removing at least some of the aqueous rinse solution from the fabric, and dosing a second aqueous rinse solution to the fabric, and rinsing the fabric in a second rinse step; and
(e) removing at least some of the second aqueous rinse solution from the fabric,
wherein the first aqueous rinse solution is free from soil release polymer, and
wherein the second aqueous rinse solution comprises a soil release polymer that is a polyester soil release polymer having a structure according to the formula below: 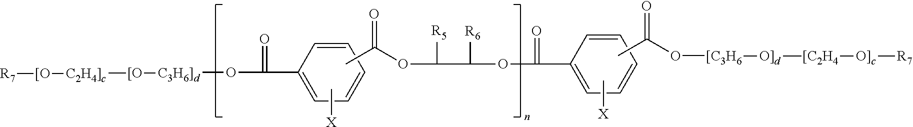
wherein:
R₅ and R₆ is independently selected from H or CH₃;
c, d are, based on molar average, a number independently selected from about 0 to about 200, and wherein the sum of c+d is from 2 to 400;
R₇ is selected from C₁₋₄ alkyl, —CH₂—CH₂—SO₃⁻(Mⁱ⁺)_{y}, or 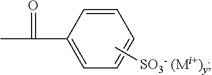
and
n is, based on molar average, from about 1 to about 50;
each X is independently selected from H or SO₃⁻(Mⁱ⁺)_{y};
wherein, M is H or a mono- or divalent cation;
i is about 1 or about 2;
y is about 0.5 or about 1; and
i×y is equal to about 1.

2. A method according to claim 1, wherein the second aqueous rinse solution comprises polyester soil release polymer.

3. A method according to claim 1, wherein the second aqueous rinse solution comprises a soil release polymer that is a nonionic terephthalate-derived soil release polymer having a structure according to the formula below: 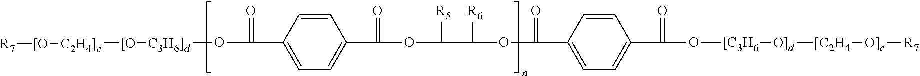
wherein:
R₅ and R₆ is independently selected from H or CH₃;
c, d are, based on molar average, a number independently selected from about 0 to about 200, and wherein the sum of c+d is from about 2 to about 400;
R₇ is C₁₋₄ alkyl and more preferably methyl; and
n is, based on molar average, from about 1 to about 50.

4. A method according to claim 1, wherein d is about 0 to about 10 and c is about 5 to about 150.

5. A method according to claim 1, wherein the second aqueous rinse solution comprises from about 40 ppm to about 120 ppm soil release polymer.

6. A method according to claim 1, wherein the laundry detergent comprises anionic surfactant and soil release polymer and wherein the aqueous wash liquor in step (b) comprises anionic surfactant and soil release polymer.

7. A method according to claim 1, wherein the majority of the aqueous wash liquor is removed from the fabric during step (c), and wherein the majority of the aqueous rinse solution is removed from the fabric during step (d), and wherein the majority of the aqueous rinse solution is removed from the fabric during step (e).

8. A method according to claim 1, wherein the first aqueous rinse solution is water.

9. A method according to claim 1, wherein the last aqueous rinse solution comprises perfume and/or fabric softening agent.

10. A method according to claim 1, wherein step (e) removes at least some of the aqueous rinse solution from the fabric, and dosing a third aqueous rinse solution to the fabric, and rinses the fabric in a third rinse step, and wherein the process comprises step (f) which removes at least some of the aqueous rinse solution.

11. A method according to claim 10, wherein the majority of the aqueous rinse solution is removed from the fabric during step (e), and wherein the majority of the aqueous rinse solution is removed from the fabric during step (f).

12. A method according to claim 10, wherein the third aqueous rinse solution is free from soil release polymer.

13. A method according to claim 10, wherein the third aqueous rinse step is the last rinse step.

14. A method according to claim 1, wherein the method is carried out in an automatic washing machine.
